(19) United States
(12) Patent Application Publication
(10) Pub. No.: US 2005/0262445 A1
(43) Pub. Date: Nov. 24, 2005

(54) Information-processing apparatus and display control method

(75) Inventors: Shigeru Kizaki, Ome-shi (JP); Tsutomu Iwaki, Hanno-shi (JP); Hiroaki Chiba, Sagamihara-shi (JP); Masaya Endo, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/134,510

(22) Filed: May 23, 2005

(30) Foreign Application Priority Data
May 24, 2004 (JP) 2004-153718

(51) Int. Cl. G11B 27/00; H04N 5/44

(52) U.S. Cl. 715/718; 348/558

(57) ABSTRACT

An information-processing apparatus comprises a graphics controller which generates a video signal, a video processing controller which improves an image quality with respect to the video signal generated by the graphics controller, a detecting unit which detects whether or not a display mode of a display device is a full screen mode, and a control unit which sets a display control mode to a high image quality mode when it is detected that the display mode is the full screen mode, and wherein the video signal from the graphics controller is transmitted to the display device via the video processing controller in the high image quality mode.

### CROSS-REFERENCE TO RELATED APPLICATIONS

This application is based upon and claims the benefit of priority from prior Japanese Patent Application No. 2004-153718, filed May 24, 2004, the entire contents of which are incorporated herein by reference.

### BACKGROUND OF THE INVENTION

1. Field of the Invention

The present invention relates to an information-processing apparatus for displaying, on a display device, a moving image corresponding to moving image data and a display control method for use in the apparatus.

2. Description of the Related Art

In recent years, personal computers with an AV reproduction function equivalent to that of such audio/visual (AV) equipment as a digital versatile disc (DVD) player and a TV device have been developed.

For example, in Jpn. Pat. Appln. KOKAI Publication No. 2002-108486, there is disclosed a personal computer in which a DVD drive apparatus and a TV tuner are installed. In the computer in Jpn. Pat. Appln. KOKAI Publication No. 2002-108486, after a video signal obtained from the TV tuner is processed by an image controller, and is directly displayed on an display unit directly connected to the image controller.

By the way, in order to display a moving image obtained by a DVD drive apparatus or a TV tuner with a sufficiently high image quality, a function of executing video signal processing for generating the moving image high image quality is required. However, such a video signal processing function for a moving image is not provided in the above-described Jpn. Pat. Appln. KOKAI Publication No. 2002-108486.

Further, video signal processing for a moving image is mainly used for image enhancement. Therefore, if video signal processing for a moving image is applied with respect to a static image such as text or graphics, the visibility of the static image is further deteriorated due to it in some cases.

### BRIEF SUMMARY OF THE INVENTION

According to an aspect of the present invention, there is provided an information-processing apparatus comprising: a graphics controller configured to generate a video signal; a video processing controller configured to improve an image quality with respect to the video signal generated by the graphics controller; a detecting unit configured to detect whether or not a display mode of a display device is a full screen mode; and a control unit configured to set a display control mode to a high image quality mode when it is detected that the display mode is the full screen mode, and wherein the video signal from the graphics controller is transmitted to the display device via the video processing controller in the high image quality mode.

### BRIEF DESCRIPTION OF THE SEVERAL VIEWS OF THE DRAWING

FIG. 1 is a perspective view of an appearance of a computer according to an embodiment of the present invention;

FIG. 2 is a block diagram showing a system structure of the computer of FIG. 1;

FIG. 3 a block diagram showing a configuration of a high-quality video engine provided in the computer of FIG. 1;

FIG. 4 is a flowchart showing the procedure of display control processing executed in the computer of FIG. 1;

FIG. 5 is a diagram for respectively explaining flows of video signals in a normal mode and a high-image-quality mode which are used in the computer of FIG. 1;

FIG. 6 is a flowchart showing one concrete example of the display control processing executed in the computer of FIG. 1;

FIG. 7 is a diagram showing an example of an interface for setting scaling parameters in the high-quality video engine provided in the computer of FIG. 1; and

FIG. 8 is a diagram for explaining an example of scaling processing executed in the computer of FIG. 1.

### DETAILED DESCRIPTION OF THE INVENTION

Hereinafter, an embodiment of the present invention will be described with reference to the drawings.

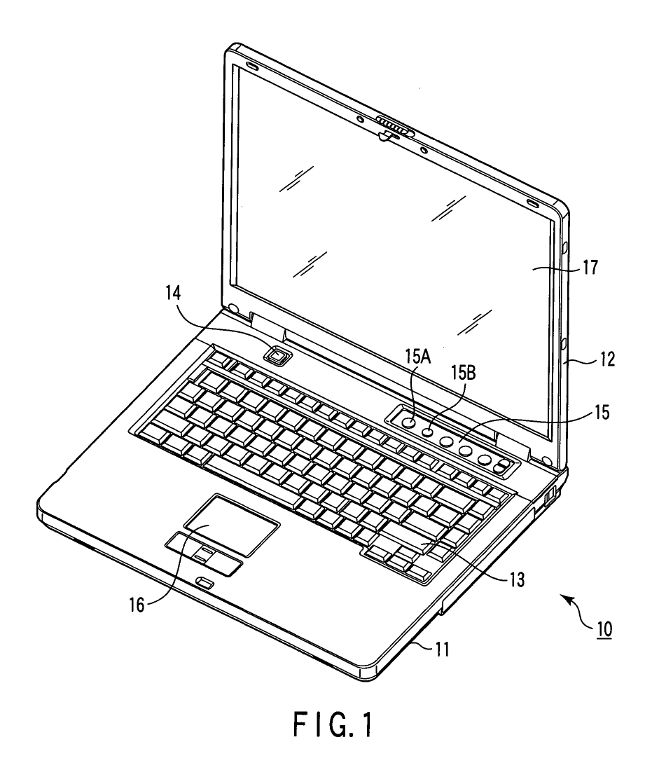

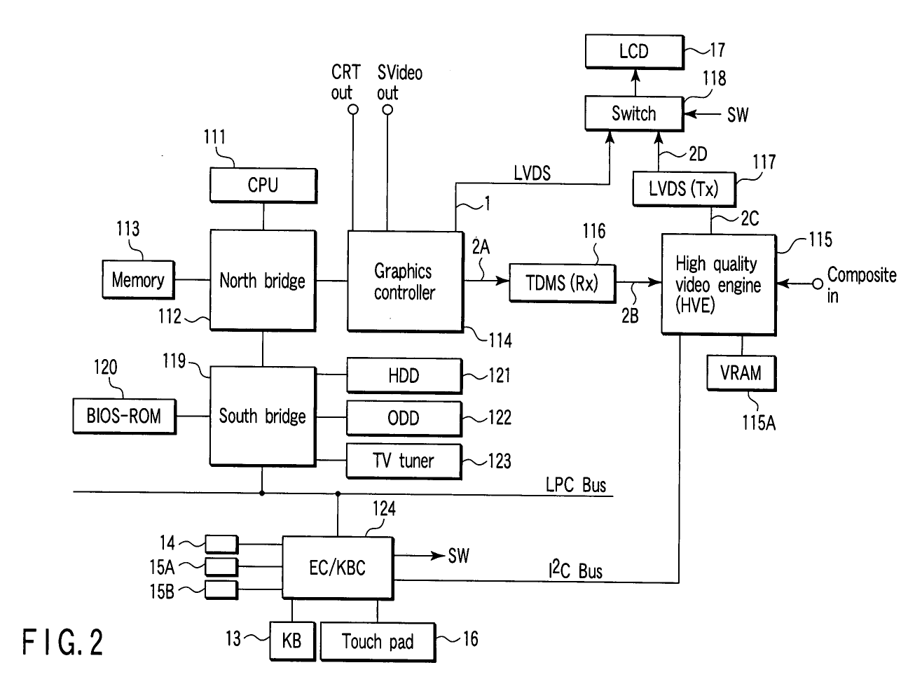

First, a configuration of an information-processing apparatus according to one embodiment of the present invention will be described with reference to FIGS. 1 and 2. The information-processing apparatus is realized as, for example, a notebook-type personal computer 10.

FIG. 1 is a front elevation of the notebook-type personal computer 10 in a state in which a display unit is opened. The computer 10 is composed of a computer main body 11 and the display unit 12. A display device configured by a liquid crystal display (LCD) 17 is built into the display unit 12, and a display screen of the LCD 17 is positioned at substantially the center of the display unit 12.

The display unit 12 is attached so as to be freely rotatable between an open position and a close position with respect to the computer main body 11. The computer main body 11 has a thin box type housing, and a keyboard 13, a power button 14 for turning the power source of the computer 10 on/off, an input operation panel 15, a touch pad 16, and the like are disposed on the top surface thereof.

The input operation panel 15 is an input device for inputting an event corresponding to a button which has been pushed, and the panel has a plurality of buttons for respectively starting a plurality of functions. A TV starting button 15A and a DVD/CD starting button 15B are included in a group of those buttons. The TV starting button 15A is a button for reproducing TV broadcast program data. When the TV starting button 15A is pushed down by a user, an application program for reproducing TV broadcast program data is automatically started. The DVD/CD starting button 15B is a button for reproducing video contents recorded on a DVD or a CD. When the DVD/CD starting button 15B is pushed down by a user, an application program for reproducing video contents is automatically started.

In order to display a moving image corresponding to moving image data such as TV broadcast program data or video contents with a high image quality on the LCD 17, the computer 10 in the present embodiment has a function of automatically making the image quality of the moving image have high image quality at the time of reproducing the moving image.

Next, the system configuration of the computer 10 will be described with reference to FIG. 2.

As shown in FIG. 2, the computer 10 has a CPU 111, a north bridge 112, a main memory 113, a graphics controller 114, a high quality video engine (HVE) 115, a TMDS (Rx) processing unit 116, an LVDS (Tx) processing unit 117, a switch 118, a south bridge 119, a BIOS-ROM 120, a hard disk drive (HDD) 121, an optical disk drive (ODD) 122, a TV tuner 123, and an embedded controller/keyboard controller IC (EC/KBC) 124.

The CPU 111 is a processor provided for control-ling the operation of the computer 10, and executes an operating system (OS) and various application programs which are loaded from the hard disk drive (HDD) 121 into the main memory 113. The OS has a window system for displaying a plurality of windows on the display screen.

A moving image is displayed in a window corresponding to a video playback application program for reproducing the moving image data thereof (for example, TV broadcast program data received by the TV tuner 123, video contents stored on a storage medium such as a DVD or the like). In this case, the window corresponding to the video playback application program is disposed on a desktop screen, and the moving image is displayed in the window (window mode). Further, the computer 10 can display the moving image in a full-screen mode on the display screen of the LCD 17. In this full-screen mode, only the moving image is displayed on a substantially entire area on the display screen. In this case, basically, the desktop screen and windows corresponding to the application programs other than the video playback application program are not displayed. Further, a menu bar and the like of the window corresponding to the video playback application program are not displayed, and only the moving image is displayed on the substantially entire area on the display screen.

Further, the CPU 111 executes a system basic input output system (BIOS) stored in the BIOS-ROM 120 as well. The system BIOS is a program for controlling hardware.

The north bridge 112 is a bridge device which connects between a local bus of the CPU 111 and the south bridge 119. A memory controller which access-controls the main memory 113 is built in the north bridge 112. Further, the north bridge 112 has a function of executing communication with the graphics controller 114 via an accelerated graphics port (AGP) bus or the like.

The graphics controller 114 is a display controller for controlling the LCD 17 used as a display monitor of the computer 10. This graphics controller 114 has a video memory (VRAM), and generates a video signal for forming a display image to be displayed on the LCD 17 based on display data drawn in the video memory by the OS/application programs. The display image to be displayed on the LCD 17 is usually formed from an image on the desktop screen and respective images on the windows disposed on the desktop screen. However, when a moving image is displayed in a full-screen mode, a display image to be displayed on the LCD 17 is composed of only the image of the moving image. Accordingly, when a moving image is displayed in a full screen mode, a video signal forming only the display image of the moving image is output from the graphics controller 114.

Video signals generated by the graphics controller 114 are respectively output to a line 1 and a line 2A. A video signal to be output to the line 1 is structured from, for example, a low-voltage differential signaling (LVDS) type 18-bit signal. Further, a video signal to be output to the line 2A is structured from, for example, a transition minimized differential signaling (TDMS) type 24-bit signal. The graphics controller 114 also has an interface for outputting an analog video signal to an external cathode-ray tube (CRT), and an interface for outputting an analog video signal extending via an S-video terminal.

The TMDS (Rx) processing unit 116 converts the TDMS type 24-bit signals transmitted via the line 2A from the graphics controller 114 into an RGB digital signal, and transmits the 24-bit RGB digital signal to the high-quality video engine (HVE) 115 via a line 2B.

The high quality video engine (HVE) 115 is a video processing controller for executing video processing for making a first video signal generated by the graphics controller 114 in a high image quality (hereinafter image quality correction processing). The high quality video engine (HVE) 115 has a video memory (VRAM) 115A. The image quality correction processing is executed on the video memory (VRAM) 115A. This image quality correction processing is video processing dedicated for moving image for making a moving image in a high image quality, and is executed for displaying a smooth and high image quality moving image on the LCD 17. In this image quality correction processing, in order to improve the image quality of the moving image, for example, a color correction (a gamma control, a white balance adjustment, a brightness adjustment, a contrast adjustment), a sharpness adjustment, and an edge enhancement, and processing for improving the speed of response of the LCD are carried out.

Further, the HVE 115 can apply image quality correction processing with respect to a video signal to be input from an external video equipment via a composite input terminal.

The video signal to which image quality correction processing has been applied by the HVE 115 is transmitted to the LVDS (Tx) processing unit 117 via a line 2C. The LVDS (Tx) processing unit 117 converts the RGB digital signal, to which image quality correction has been applied and which is output from the high quality video engine (HVE) 115, into an LVDS-type signal, and outputs the LVDS type signal onto a line 2D.

Moreover, the HVE 115 has a scaling function for varying the resolution and an aspect ratio of a video signal. Scaling for a video signal is executed after image quality correction processing with respect to the video signal is executed. The moving image in a case in which image quality correction processing is applied with respect to raw data before scaling, and scaling is carried out to the video signal on which image quality correction processing has been applied can be displayed with a higher image quality than the moving image in a case in which image quality correction is applied onto a video signal to which scaling has been carried out.

The switch 118 functions as a selector which selectively outputs one of the video signal generated by the graphics controller 114 and the video signal to which image quality correction has been applied by the HVE 115 to the LCD 17. The switch 118 has a first input terminal connected to the line 1, a second input terminal connected to the line 2D, and an output terminal connected to the LCD 17. The switch 118 is configured to select one of the first input terminal and the second input terminal in accordance with a switch control signal SW supplied from the EC/KBC 124, and to connect the selected input terminal to the output terminal. Due to this effect of the switch 118, in the present embodiment, the following two display control modes can be used.

(1) Normal mode: In a normal mode, a video signal from the graphics controller 114 is transmitted to the LCD 17 without passing through the HVE 115. A normal mode is used when a static image is included in a display image displayed on the LCD 17.

(2) High-image-quality mode: In a high-image-quality mode, the video signal from the graphics controller 114 is transmitted to the LCD 17 via the HVE 115. The high-image-quality mode is used when a static image is not included in a display image displayed on the LCD 17, i.e., when a moving image is displayed in a full-screen mode. This is because, if image quality correction processing for a moving image is applied with respect to a static image (a desktop screen, an operating screen for word processor software, an operating screen for spreadsheet software), the sharpness thereof is made too strong, and the visibility of the static image is further degraded.

The south bridge 119 controls respective devices on a low-pin-count (LPC) bus. Further, the south bridge 119 has an integrated drive electronics (IDE) controller for controlling the HDD 121 and the ODD 122 built-in. Moreover, the south bridge 119 has a function of controlling the TV tuner 123, and a function for access-controlling the BIOS-ROM 120.

The ODD 122 is a drive unit for driving a storage medium such as a DVD or a CD on which video content is stored. The TV tuner 123 is a receiver device for receiving broadcast program data such as a TV broadcast program.

The EC/KBC 124 is a single-chip microcomputer in which an embedded controller for power management and a keyboard controller for controlling the keyboard (KB) 13 and the touch pad 16 are integrated. The EC/KBC 124 has a function of turning the power of the computer 10 on/off in accordance with the operation of the power button 14 by a user.

Moreover, the EC/KBC 124 has a function of carrying out communication with the HVE 115 via an I²C bus, and a function of supplying the switch control signal SW described above for the switch 118.

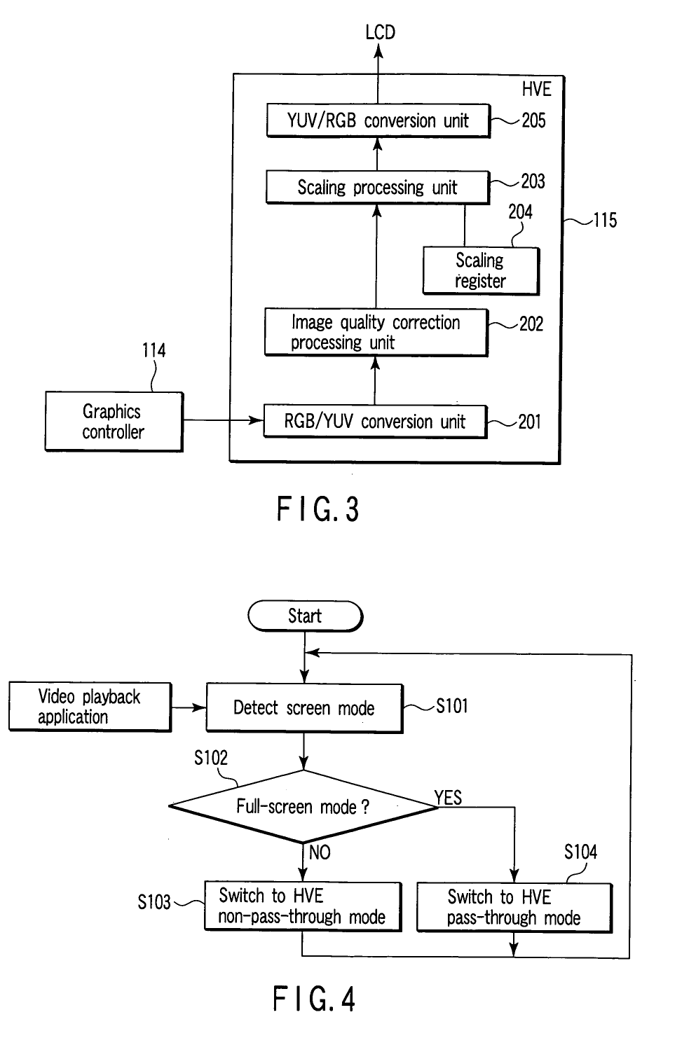

Next, a configuration example of the HVE 115 will be described with reference to FIG. 3.

As shown in the drawing, the HVE 115 has an RGB/YUV conversion unit 201, an image quality correction processing unit (video processing controller) 202, a scaling processing unit 203, a scaling register 204, a YUV/RGB conversion unit 205, and the like.

The RGB/YUV conversion unit 201 converts the video signal transmitted from the graphics controller 114 via the TMDS (Rx) processing unit 116 from an RGB signal into a YUV signal. The image quality correction processing unit 202 applies arithmetic processing for the image quality correction thereof (color adjustment, sharpness adjustment, brightness adjustment, and edge enhancement) with respect to the YUV signal. The scaling processing unit 203 carries out scaling of the YUV signal to which image quality correction has been applied in accordance with scaling parameter information set in the scaling register 204.

Scaling is processing for varying the size (resolution) of a moving image. Due to this scaling processing, the size (resolution) of the moving image is varied to a size fitted to a size (panel resolution) of the display screen of the LCD 17. The scaling parameter information includes, for example, the resolution of the moving image, an aspect ration of the moving image, the panel resolution of the LCD 17, and the like.

The YUV/RGB conversion unit 205 converts the video signal onto which scaling has been carried out from a YUV signal into an RGB signal. This RGB signal is transmitted to the LCD 17.

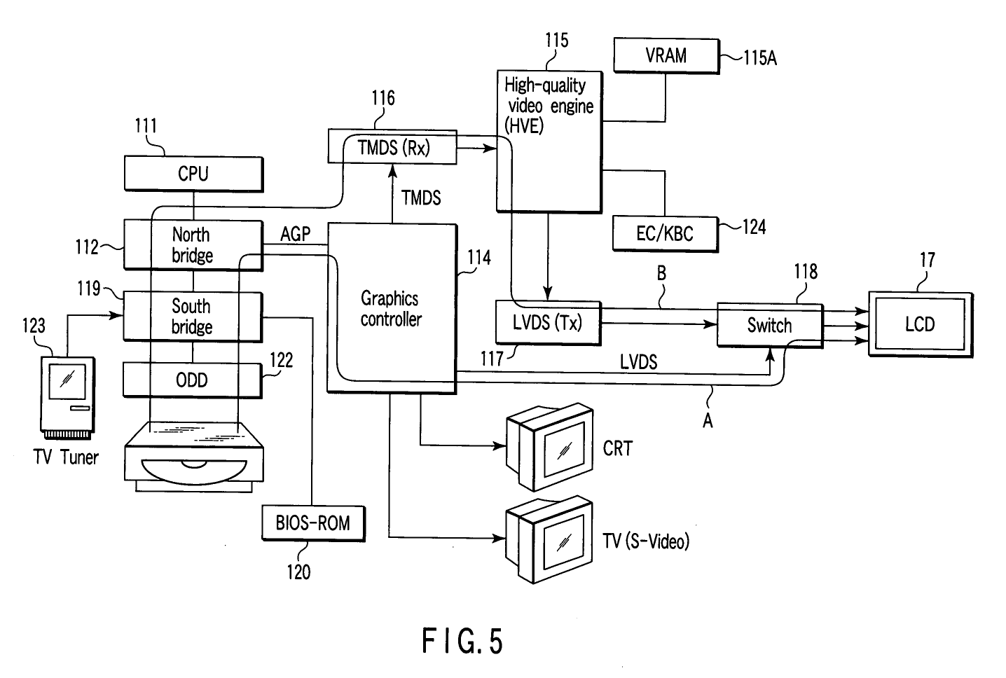

Next, display control processing executed by the computer 10 will be described with reference to the flowchart of FIG. 4.

The CPU 111 detects, for example, whether or not a current display mode for displaying a moving image is a full-screen mode in accordance with the presence/absence of a full-screen mode request from a video playback application for reproducing moving image data (step S101). In this case, the CPU 111 detects that the current display mode for displaying a moving image is a full-screen mode in response to a full-screen mode request being issued from the video playback application program to, for example, a display driver. The display driver is a program for controlling the graphics controller 114.

When the current display mode for displaying a moving image is not a full-screen mode (NO in step S102), the CPU 111 switches the display control mode, which is for transmitting the video signal from the graphics controller 114 to the LCD 17, to a mode in which the video signal is transmitted to the LCD 17 without passing through the HVE 115 (normal mode) (step S103). On the other hand, when the current display mode for displaying a moving image is a full-screen mode (YES in step S102), the CPU 111 switches the display control mode to a mode in which the video signal is transmitted to the LCD 17 via the HVE 115 (high-image-quality mode) (step S103).

Transfer routes of the moving images respectively in a normal mode and a high-image-quality mode are shown in FIG. 5. In FIG. 5, a case in which a moving image recorded on a DVD medium is displayed on the LCD 17 is assumed.

In a normal mode, as shown by full line A of FIG. 5, the moving image data reproduced from the DVD medium by the ODD 122 is transmitted to the LCD 17 via the graphics controller 114 and the switch 118, through the south bridge 119 and the north bridge 112. At the graphics controller 114, a video signal corresponding to a current display image is generated. Because the current display mode for the moving image is not a full-screen mode, for example, a video signal corresponding to a display image including a static image such as the desktop screen and a moving image reproduced from the DVD medium is generated. When the panel resolution of the LCD 17 is, for example, 1280×800, the resolution of the video signal generated by the graphics controller 114 as well is 1280×800. Then, this video signal is transmitted to the LCD 17 without passing through the HVE 115.

In a high-image-quality mode, as shown by full line B of FIG. 5, the moving image data reproduced from the DVD medium by the ODD 122 is transmitted to the LCD 17 via the graphics controller 114, the TMDS (Rx) processing unit 116, the HVE 115, the LVDS (Tx) processing unit 117, and the switch 118, through the south bridge 119 and the north bridge 112. At the graphics controller 114, a video signal corresponding to a current display image is generated. Because the current display mode for the moving image is a full-screen mode, a video signal corresponding to a display image including only a moving image is generated. The resolution of the video signal is equal to the resolution (720×480 or 720×576) of raw data reproduced from the DVD medium. Then, image quality correction is applied to this video signal by the HVE 115, and after the video signal is converted into a resolution (for example, 1280×800) for displaying a moving image in a full-screen mode, the video signal is transmitted to the LCD 17. Note that, in practice, scaling for resolution conversion is executed in consideration of the aspect ratio of the moving image.

In this way, in the embodiment, the HVE 115 executes scaling processing as well in a case of only image quality correction processing. Therefore, when the display mode for the moving image is a full-screen mode, the graphics controller 114 outputs, not a video signal having a resolution of 1280×800, but also a video signal having a resolution (for example, 720×480 or 720×576) of the moving image before scaling. At the HVE 115, scaling is carried out with respect to a video signal having a resolution of 720×480 or 720×576 so as to be a size fitted to the panel resolution of 1280×800 of the LCD 17.

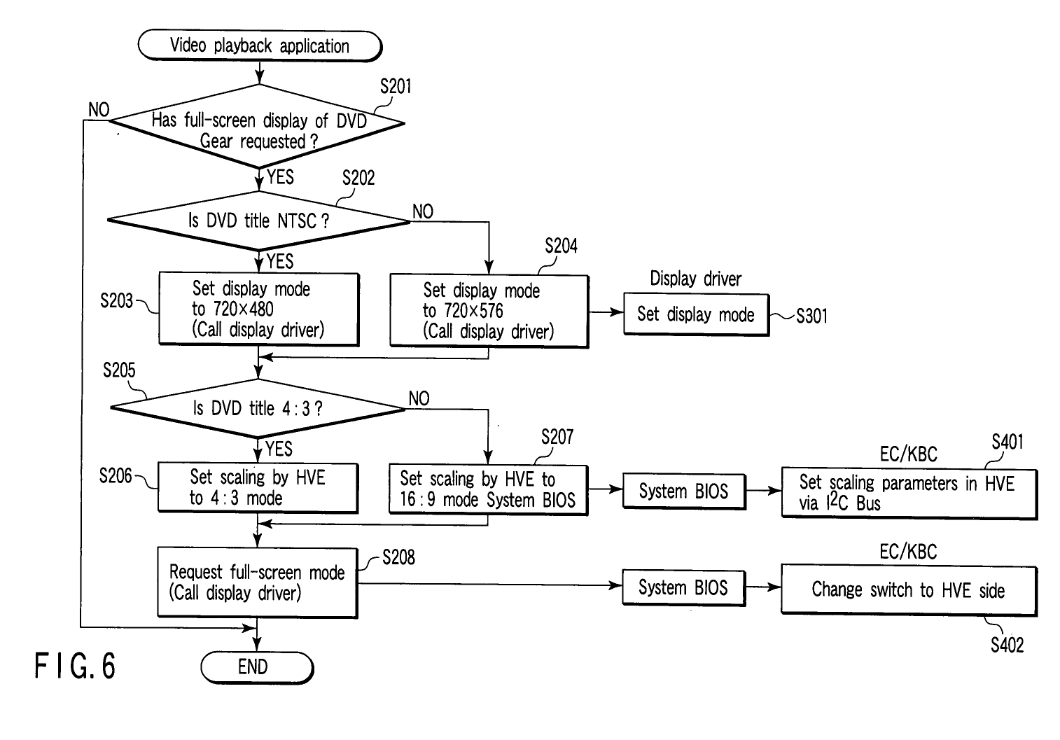

Next, an example of the procedure of a series of display control processing executed for displaying a moving image will be described with reference to the flowchart of FIG. 6. Here, a case in which a moving image is displayed on the LCD 17 due to moving image data stored on a DVD medium being reproduced is supposed.

The video playback application program starts processing for reproducing the moving image data (DVD title) stored on a DVD medium. For example, when full-screen mode (full-screen display) is designated by the operation of the keyboard 13 or the touch pad 16 by a user during the time of reproducing the moving image data (YES in step S201), the video playback application program reads information showing whether the DVD title which is being reproduced corresponds to the National Television System Committee (NTSC) standard or the Phase Alternation by Line (PAL) standard from the DVD medium.

When the DVD title which is being reproduced corresponds to the NTSC standard (YES in step S202), the video playback application program requires the display driver to set a display mode corresponding to the resolution of 720×480 (step S203). On the other hand, when the DVD title which is being reproduced corresponds to the PAL standard (NO in step S202), the video playback application program requires the display driver to set a display mode corresponding to the resolution of 720×576 (step S204).

The display driver sets the graphics controller 114 to a display mode (720×480 or 720×576) designated by the video playback application program (step S301). Usually, the graphics controller 114 is set to a display mode corresponding to the panel resolution (1280×800). Accordingly, by the processing in step S301, the resolution of the video signal generated by the graphics controller 114 is varied from 1280×800 to 720×480 or 720×576.

Next, the video playback application program reads title information showing the aspect ratio of the moving image of the DVD title which is being reproduced from the DVD medium. When the aspect ratio of the moving image of the DVD title which is being reproduced is 4:3 (YES in step S205), the video playback application program executes processing for setting the scaling by the HVE 115 to a 4:3 mode (step S206).

Further, when the aspect ratio of the moving image of the DVD title which is being reproduced is 16:9 (NO in step S205), the video playback application program executes processing for setting the scaling by the HVE 115 to a 16:9 mode (step S207).

In steps S206 and S207, respectively, the title information showing the aspect ratio of the DVD title which is being reproduced and the resolution information showing the resolution of the DVD title are set as scaling parameters in the scaling register 204 of the HVE 115, via the system BIOS, the EC/KBC 124, and the I²C bus (step S401).

Next, the video playback application program requires the varying of the display mode for the moving image to a full-screen mode, for example, by issuing a full-screen mode request to the display driver (step S208). The system BIOS is notified via the display driver of the event showing that the request for a full-screen mode is issued. Moreover, the EC/KBC 124 is notified via the system BIOS of this event. The EC/KBC 124 executes processing of switching the switch 118 to the side of the HVE 115 by the switch control signal SW (step S402). The display driver controls the graphics controller 114 to vary the display mode for the moving image to full-screen mode. In accordance therewith, the graphics controller 114 generates a video signal corresponding to only the moving image based on moving image data written into the video memory of the graphics controller 114 by the video playback application. This video signal has a resolution designated in step S203 or step S204. The video signal from the graphics controller 114 is transmitted to the HVE 115, and after image quality correction is applied thereto, scaling is carried out with respect thereto. Then, the video signal on which image quality correction and scaling have been carried out is transmitted to the LCD 17 via the switch 118.

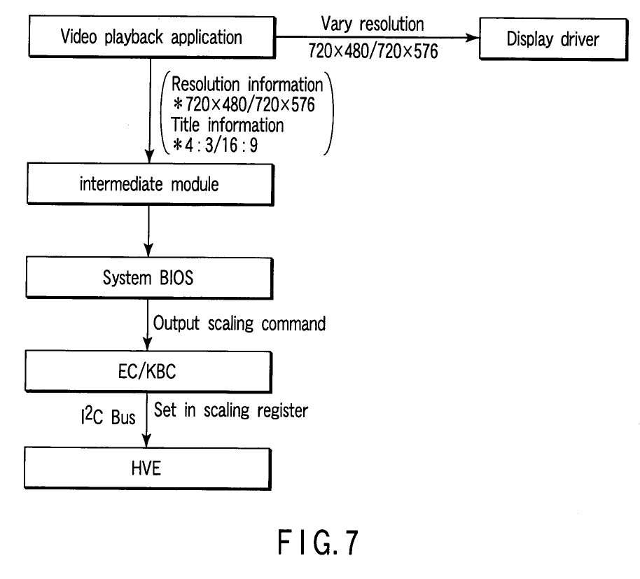

FIG. 7 shows an example of an interface for setting scaling parameters in the HVE 115.

The system BIOS is notified from the video playback application program of the resolution information (720×480/720×576) and the title information (4:3/16:9) of the DVD title which is being reproduced. The EC/KBC 124 sets the resolution information (720×480/720×576) and the title information (4:3/16:9) as scaling parameters in the scaling register 204 of the HVE 115 in accordance with a scaling command from the system BIOS.

The HVE 115 executes scaling processing based on the aspect ratio of the moving image, the resolution of the moving image (a resolution of the video signal transmitted from the graphics controller 114), and the panel resolution of the LCD 17. In this case, a magnification corresponding respectively in the horizontal direction and the vertical direction is calculated such that the moving image is displayed in a size fitted to a panel resolution of the LCD 17 while maintaining the aspect ratio of the moving image. Accordingly, the moving image can be displayed in a full-screen mode on the display screen of the LCD 17 while maintaining the aspect ratio of the moving image. It goes without saying that the resolution of the moving image may be converted into the panel resolution regardless of the aspect ratio of the moving image. In this case, the magnification corresponding respectively in the horizontal direction and the vertical direction is calculated based on the resolution of the moving image (the resolution of the video signal transmitted from the graphics controller 114) and the panel resolution of the LCD 17.

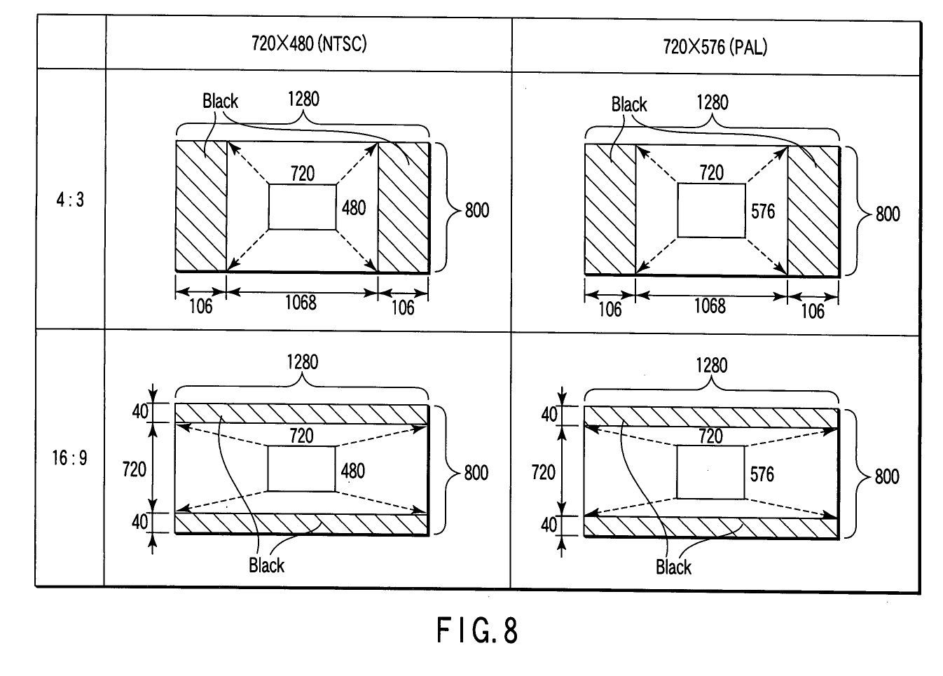

Next, an example of concrete scaling processing will be described with reference to FIG. 8.

A moving image corresponding to the NTSC standard is composed of a frame having the resolution of 720×480 even in any of the cases in which the aspect ratio is 4:3 and 16:9. With respect to the frame corresponding to a moving image of 16:9, the image is compressed in advance in the horizontal direction so as to be able to display a normal image when scaling is carried out with respect to the frame in the ratio of 16:9.

The HVE 115 carries out scaling with respect to the frame of the moving image based on an aspect ratio of the moving image (4:3 or 16:9), the resolution of the moving image (720×480), and the resolution of the LCD panel 17 (1280×800). When the aspect ratio of the moving image is 4:3, the frame of 720×480 is scaled up to 1068×800. The frame of 1068×800 is displayed at the center of the display screen of 1280×800. The both sides of the left and right of the frame of 1068×800 are made blank regions (or black regions), and no image is displayed in the regions. On the other hand, when the aspect ratio of the moving image is 16:9, the frame of 720×480 is scaled up to 1280×720. The frame of 1280×720 is displayed at the center of the display screen of 1280×800. Both sides of the top and bottom of the frame of 1280×720 are made blank regions, and no image is displayed there.

A moving image corresponding to the PAL standard is structured from a frame having the resolution of 720×576 even in any of the cases in which an aspect ratio is 4:3 and 16:9. With respect to the frame corresponding to the moving image of 16:9, the image is compressed in advance in the horizontal direction so as to be able to display a normal image when scaling is carried out with respect to the frame in the ratio of 16:9. The HVE 115 carries out scaling with respect to the frame of the moving image based on an aspect ratio of the moving image (4:3 or 16:9), the resolution of the moving image (720×576), and the resolution of the LCD panel 17 (1280×800). When the aspect ratio of the moving image is 4:3, the frame of 720×576 is scaled up to 1068×800. The frame of 1068×800 is displayed at the center of the display screen of 1280×800. No image is displayed on both sides of the left and right of the frame of 1068×800. On the other hand, when the aspect ratio of the moving image is 16:9, the frame of 720×576 is scaled up to 1280×720. The frame of 1280×720 is displayed at the center of the display screen of 1280×800. No image is displayed on both sides of the top and bottom of the frame of 1280×720.

In accordance therewith, the moving image can be displayed in a full screen in a size fitted to the size of the display screen of the LCD 17 while maintaining the aspect ratio of the moving image.

As described above, in the present embodiment, because the display control mode is automatically switched from a normal mode to a high image quality mode when a moving image is displayed in a full screen mode, the image quality of the moving image can be improved without bringing about the adverse effect that the visibility of the static image is deteriorated.

Further, in the embodiment, scaling is carried out after the image quality of the video signal is corrected. However, the image quality of the video signal onto which scaling has been carried out by the graphics controller 114 may be corrected by the high quality video engine (HVE) 115.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information-processing apparatus comprising:
a graphics controller configured to generate a video signal;
a video processing controller configured to improve an image quality with respect to the video signal generated by the graphics controller;
a detecting unit configured to detect whether or not a display mode of a display device is a full screen mode; and
a control unit configured to set a display control mode to a high image quality mode when it is detected that the display mode is the full screen mode, and wherein the video signal from the graphics controller is transmitted to the display device via the video processing controller in the high image quality mode.

2. The information-processing apparatus according to claim 1, further comprising a selector to selectively output one of the video signal outputted from the graphics controller and the video signal outputted from the video processing controller, to the display device, wherein
the control unit switches the display control mode between a normal mode and the high image quality mode by controlling the selector, and wherein the video signal outputted from the graphics controller is transmitted to the display device without passing through the video processing controller in the normal mode.

3. The information-processing apparatus according to claim 1, wherein the detecting unit includes means for detecting that the display mode is the full screen mode in accordance with a request to designate the full screen mode which is issued from an application program for reproducing the video signal.

4. The information-processing apparatus according to claim 1, further comprising a receiver device which receives broadcast data, and wherein
the graphic controller generates a video signal based on the broadcast data received by the receiver device.

5. The information-processing apparatus according to claim 1, further comprising a drive unit which drives a storage medium, and wherein
the graphic controller generates a video signal based on the data reproduced from the storage medium by the drive unit.

6. A display control method for displaying a moving image on a display device of an information-processing apparatus, the information-processing apparatus including a graphics controller which generates a video signal corresponding to a display image to be displayed on the display device, and a video processing controller which improves an image quality of the video signal generated by the graphics controller, the method comprising:
detecting whether or not a display mode for displaying the moving image is a full screen mode; and
setting a display control mode wherein to a high image quality mode when it is detected that the display mode is the full screen mode, and wherein the video signal outputted from the graphics controller is transmitted to the display device via the video processing controller in the high image quality mode.

7. The display control method according to claim 6, wherein the information-processing apparatus further includes a selector which selectively outputs one of the video signal outputted from the graphics controller and the video signal outputted from the video processing controller, to the display device, and wherein the setting comprising setting the display control mode to the high image quality mode by making the selector to selectively output the video signal outputted from the video processing controller.

8. The display control method according to claim 6, wherein the detecting detects that the display mode is the full screen mode in accordance with a request to designate the full screen mode which is issued from an application program for reproducing the video signal.

9. The display control method according to claim 6, wherein the information-processing apparatus further includes a receiver device which receives broadcast data, and
the graphic controller generates a video signal based on the broadcast data received by the receiver device.

10. The display control method according to claim 6, wherein the information-processing apparatus further has a drive unit which drives a storage medium, and
the graphic controller generates a video signal based on the data reproduced from the storage medium by the drive unit.
